(19) United States
(12) Patent Application Publication
(10) Pub. No.: US 2014/0108523 A1
(43) Pub. Date: Apr. 17, 2014

(54) CONNECTION SHARING ACROSS ENTITIES IN A DISTRIBUTED MESSAGING SYSTEM

(71) Applicant: MICROSOFT CORPORATION, Redmond, WA (US)

(72) Inventors: Kartik Paramasivam, Redmond, WA (US); Jayteerth Katti, Redmond, WA (US); Hiu-Ming Eric Lam, Bellevue, WA (US); David Leon Stucki, Bellevue, WA (US)

(73) Assignee: Microsoft Corporation, Redmond, WA (US)

(21) Appl. No.: 13/650,129

(22) Filed: Oct. 12, 2012

(51) Int. Cl. G06F 15/16

(52) U.S. Cl. 709/204

(57) ABSTRACT

A method of creating a link of a connection to a messaging system includes receiving a protocol command message directed to a message entity of the messaging system. The protocol command message is communicated over the connection. The method includes determining that the protocol command message includes a link identifier that is unrecognized by the messaging system and in response to receiving the protocol command message and determining that the protocol command message includes the link identifier that is unrecognized by the messaging system, creating the link for the connection, the link corresponding to the link identifier.

### PRIORITY CLAIM

The present application claims priority to U.S. patent application Ser. No. 13/420,620, filed Mar. 15, 2012, entitled “Distributed Messaging System Connectivity and Resource Management”, which claims priority from Provisional Application No. 61/532,037 filed on Sep. 7, 2011 and entitled “SERVICE BUS FLOW CONTROL, REQUEST CONTROL, MESSAGE CONNECTIVITY AND CAPACITY MANAGEMENT,” each of which is hereby incorporated by reference in its entirety.

### BACKGROUND

A messaging system that uses a service bus architecture may support a set of cloud-based, message-oriented-middleware technologies including message queuing and message publication/subscription. The messaging system utilizes decoupled communication to support message publication, subscription, and load balancing scenarios. Using such a messaging system, clients and servers can perform their operations in an asynchronous fashion.

A single client may manage a large number of queues or topics. In one approach, a network connection is provided between the client and a messaging service for each message sender or message receiver (queue or topic) that the client interacts with. A drawback of this approach is that if the client connects to a large number of queues or topics, an equally large number of network connections are established.

When a single client requests to perform a protocol command with a queue or topic (such as to publish a message or to consume a published message), the client may indicate which queue or topic it is dealing with, provide credentials, and convey which protocol command is being performed. The client can be connected to the queue or topic once and then multiple protocol commands may be performed. Thus, establishing a connection between the client and the queue or topic is typically performed as a separate step from the protocol commands and therefore utilizes a separate network round trip, which increases the latency of message communication at the client.

### SUMMARY

The present disclosure relates to a distributed messaging system. The distributed messaging system includes a gateway having an interface to receive client messages and having access to a gateway database.

In order to reduce a number of network/socket connections between a client and the messaging system, the client can use a single network/socket connection to interact with multiple queues or topics. This shared network/socket connection is referred to as a connection.

Each connection may contain any number of logical child connections referred to as links. Each link is associated with a specific queue or topic and is unidirectional (i.e., for communication with either a message sender/publisher or a message receiver/consumer).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a particular embodiment of a distributed messaging system;

FIG. 2-3 are flow diagrams of embodiments of methods of operation of the distributed messaging system of FIG. 1;

FIG. 4 is a block diagram of another particular embodiment of a distributed messaging system;

FIGS. 5-7 are flow diagrams of embodiments of methods of operation of the distributed messaging system of FIG. 4; and

FIG. 8 is a diagram of a computer system that may be used in connection with the distributed messaging system of FIGS. 1 and 4.

### DETAILED DESCRIPTION

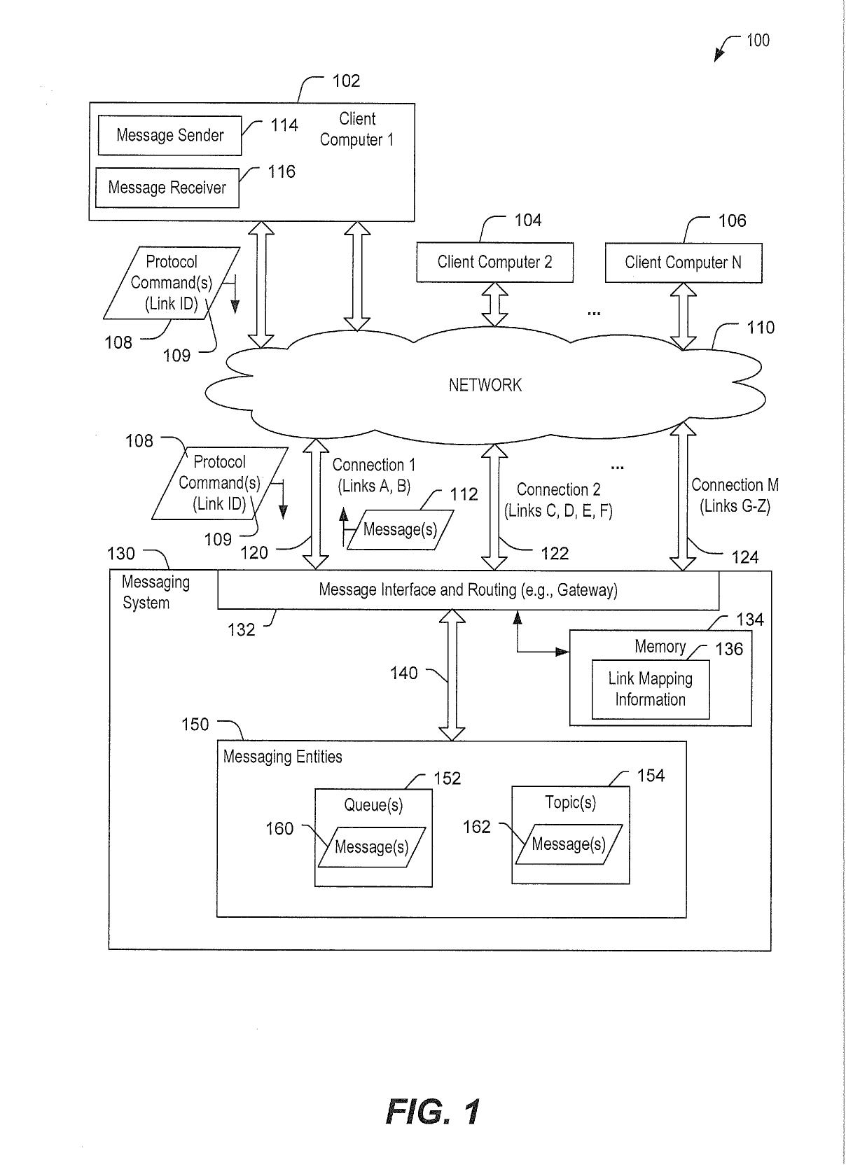

Referring to FIG. 1, a particular illustrative embodiment of a distributed computing system 100 is shown. The distributed computing system 100 includes one or more client computers (such as a representative first client computer 102, a representative second client computer 104, and a representative N^{th} client computer 106), a computer network 110, and a messaging system 130. The messaging system 130 includes a message interface and routing component 132 (such as a gateway or router), a memory 134, and messaging entities 150. The messaging interface and routing component 132 is coupled to the messaging entities 150 via an internal communication mechanism, such as the bus 140. Examples of messaging entities, including various queues 152 and topics 154, are shown. A queue 152 includes one or more messages, such as the illustrated message 160, and the topics 154 include one or more messages, such as the illustrated message 162.

The memory 134 includes link mapping information 136. The link mapping information 136 maps each of a plurality of links supported by one or more connections (e.g. connections between the messaging system 130 and the client computers 102, 104, 106) that enable communication of messages with respect to the messaging entities 150.

The messaging system 130 is coupled to the network 110 via one or more connections, such as a first connection 120, a second connection 122, and an M^{th} connection 124. The messaging system 130 is coupled via the network 110 and the connections 120, 122, 124 to the one or more client computers, such as the first client computer 102, the second client computer 104, and the N^{th} client computer 106. The first client computer 102 includes a message sender 114 and a message receiver 116. While not shown, each of the other client computers 104, 106 may also include message senders and message receivers.

Each of the connections 120, 122, 124 includes one or more links. For example, the first connection 120 includes a first link A and a second link B. The second connection 122 includes links C, D, E, and F. The M^{th} connection 124 includes other links (illustrated as links G-Z). Each of the links in any of the connections 120, 122, 124 may be used to communicate messages to or from a client computer. For example, messages to or from any of the client computers 102, 104, 106 may be communicated via the network 110 and over a particular link within one of the connections 120, 122, 124. In order to identify a particular link for communication, each of the messages includes a message header that includes a link identifier. For example, the first client computer 102 may send a protocol command message 108 that includes a message header that includes a link identifier (link ID) 109. The protocol command message 108 may be communicated from the first client computer 102 via the network 110 and over the first connection 120 to the messaging system 130.

Upon receiving the protocol command message 108, the messaging system 130 processes the protocol command message 108 and identifies the link identifier 109. The message interface and routing component 132 compares the link identifier 109 to the link mapping information 136. In the event that the link identifier 109 is identified by the link mapping information 136, then the message interface and routing component 132 routes the protocol command message 108 via the internal communication bus 140 to a particular messaging entity (e.g., one of the queues 152 or the topics 154) of the messaging entities 150.

However, if the link identifier 109 is not found within the link mapping information 136, then a new entry is created within the link mapping information 136. For example, the new entry may include information associated with a new link corresponding to the link identifier 109. The new link may be assigned to a particular queue or topic of the message entities 150. The information that maps the new link to the particular queue or topic of the messaging entities 150 is stored in the link mapping information 136 within the memory 134. In this manner, subsequent messages that include the link identifier 109 are routed to or from the particular queue or topic of the messaging entity 150.

Thus, in response to receiving a protocol command message with an unrecognized link identifier, the messaging system 130 may operate to automatically create a link corresponding to the unrecognized link identifier for a connection to the messaging system 130. For example, the first representative link A may be created by the messaging system 130 with respect to the first connection 120. To illustrate, a method of creating a link of a connection to the messaging system 130 may include receiving a message, such as the protocol command message 108, that is directed to a messaging entity of the messaging system 130. A representative messaging entity may be one of the queues 152 or topics 154 of the messaging entities 150. The protocol command message 108 is communicated over one of the connections, such as over the first connection 120. The method further includes determining that the protocol command message 108 includes a link identifier, such as the link identifier 109, that is unrecognized by the messaging system 130. For example, the messaging system 130 may determine that the link identifier 109 of the protocol command message 108 is not recognized by the messaging system 130 by evaluating data within the link mapping information 136. In response to receiving the protocol command message 108 and determining that the link identifier is unrecognized by the messaging system 130, the method includes automatically creating a link for the connection that corresponds to the link identifier. For example, an entry may be inserted into the link mapping information 136 of a link mapping table within the memory 134 in order to create data that assigns the link identifier 109 to a particular link (e.g. link A) of the connection 120.

In a particular illustrative embodiment, the protocol command message 108 is a command other than a create link command. For example, the protocol command message 108 is not dedicated for (e.g., does not direct) creation of links, but rather the link creation occurs independently of a dedicated create link message. Thus, the distributed computing system 100 may create links more efficiently and with reduced latency since a dedicated create link message is not needed.

The link identifier 109 of the protocol command message 108 may correspond to at least one communication from a client computer (e.g. client computer 102) of the messaging system 130. Any of the client computers 102, 104, 106 may send a protocol command message including a particular link ID. In a particular illustrative embodiment, each of the links is unidirectional such that a pair of links may be used to send communications to and to receive communications from a particular client computer. Also, each of the created links may have associated mapping data (such as an entry in the link mapping information 136) that associates the link identifier with a message broker of the messaging system 130. For example, the link mapping information 136 may associate a particular link identifier with a particular message broker where the message broker manages one or more of the messaging entities 150.

In a particular illustrative embodiment, the protocol command message 108 includes a link information header that indicates a messaging entity name, the link identifier 109, a link type, a receive mode, and an entity type. In a particular illustrative embodiment, the link type is one of receive, send, and control. The receive mode may be a receive mode, a delete mode, or a peak lock mode. While specific modes have been identified by way of example, the receive mode can include other modes and the application is not limited to the specifically identified modes. The entity type may be a queue or a topic, and the link information may include information indicating whether the link is associated with a session receiver.

In a particular illustrative embodiment, a method of operating the messaging system 130 may include receiving a close link command message that includes the link identifier 109 and closing the link in response to receiving the close link command message. While the close link command message is not specifically shown, it should be understood that any of the client computers 102, 104, or 106 may send the close link command message via the network 110 over one of the connections 120, 122, 124 to the messaging system 130. The close link command message may include the same link identifier as the protocol command message 108 (i.e., the link identifier 109) or may include a different link identifier corresponding to a different link. The messaging system 130, in response to receiving a close link command message having a particular link identifier, closes the link and maintains the connection corresponding to the link while closing the link. The link mapping information 136 may be updated in response to closing the link in order to maintain the link mapping information 136.

As explained above, a particular connection may include a plurality of links. For example, the second connection 122 includes four illustrated links: C, D, E, and F. During operation, the messaging system 130 may receive a close connection indication, such as a close connection message. In response to receiving the close connection indication, the connection, such as the second connection 122, is closed and each of the plurality links is closed in response to receiving the close connection indication. Thus, in this particular example, each of the links C, D, E, F is closed in response to receiving a close connection indication for the second connection 122.

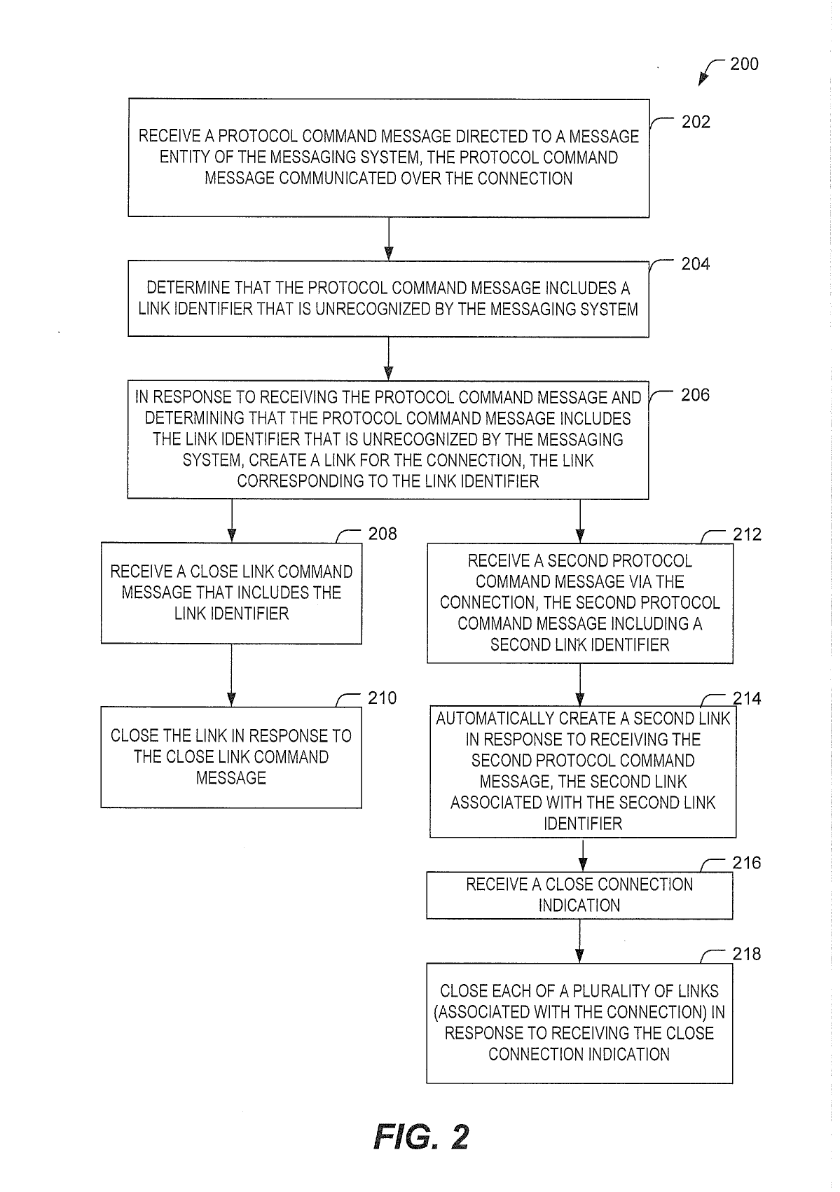

Referring to FIG. 2, a particular illustrative embodiment of a method of operating a distributed messaging system is shown and generally designated 200. The method may be performed by a distributed messaging system, such as the distributed messing system 100 of FIG. 1. The method 200 includes receiving a protocol command message directed to a message entity of the distributed messaging system, at 202. The protocol command message is communicated over a connection. For example, the message interface and routing component 132 of FIG. 1 may receive the protocol command message 108 from the first client computer 102 via the first connection 120. In this example, the protocol command message 108 may be directed to one of the messaging entities 150, such as one of the queues 152 or one of the topics 154 or to a message broker that manages one or more queues or topics.

The method 200 further includes determining that the protocol command message includes a link identifier that is unrecognized by the messaging system, at 204. For example, the link identifier 109 of the protocol command message 108 of FIG. 1 may be compared to link mapping information 136 in the memory 134 to determine whether the link identifier 109 is recognized. The method 200 further includes, in response to receiving the protocol command message and determining that the protocol command message includes the link identifier that is unrecognized by the messaging system, creating a link for the connection such that the link corresponds to the link identifier, at 206. For example, when the link mapping information 136 of FIG. 1 does not include the link identifier 109, a new entry corresponding to the link identifier 109 may be added to the link mapping information 136.

The method 200 further includes, in a particular instance, receiving a close link command message that includes the link identifier, at 208, and closing the link in response to the close link command message, at 210. For example, the first client computer 102 of FIG. 1 may send a close link command message (not shown) including the link identifier 109 to the messaging system 130 via the first connection 120. In response to the close link command message, the messaging system 130 may close the link associated with the link identifier 109. In a particular embodiment, the messaging system 130 may leave the first connection 120 open (i.e., may maintain the first connection 120) after the link is closed. The link may be closed, for example, by deleting one or more entries associated with the link identifier 109 from the link mapping information 136.

In another instance, the method 200 includes receiving a second protocol command message via the connection where the second protocol command message includes a second link identifier, at 212. The method 200 further includes automatically creating a second link in response to receiving the second protocol command message where the second link is associated with the second link identifier, at 214. For example, the first client computer 102 of FIG. 1 may send one or more additional messages to one or more of the messaging entities 150 of the messaging system 130 via the first connection 120. Communications with each of the messaging entities 150 from the first client computer 102 may be associated with a different link identifier. Thus, the first connection 120 may include multiple links (such as link A and link B). The method 200 further includes receiving a close connection indication, at 216, and closing each of a plurality of links associated with the connection in response to receiving the close connection indication, at 218. For example, in response to receiving a close connection indication from the first client computer 102 of FIG. 1, the messaging system 130 may closes the first connection 120, including closing the links A and B. To illustrate, entries for link A and link B may be deleted from the link mapping information 136. Thus, a method of automatically creating and closing links, or connections including multiple links, has been described.

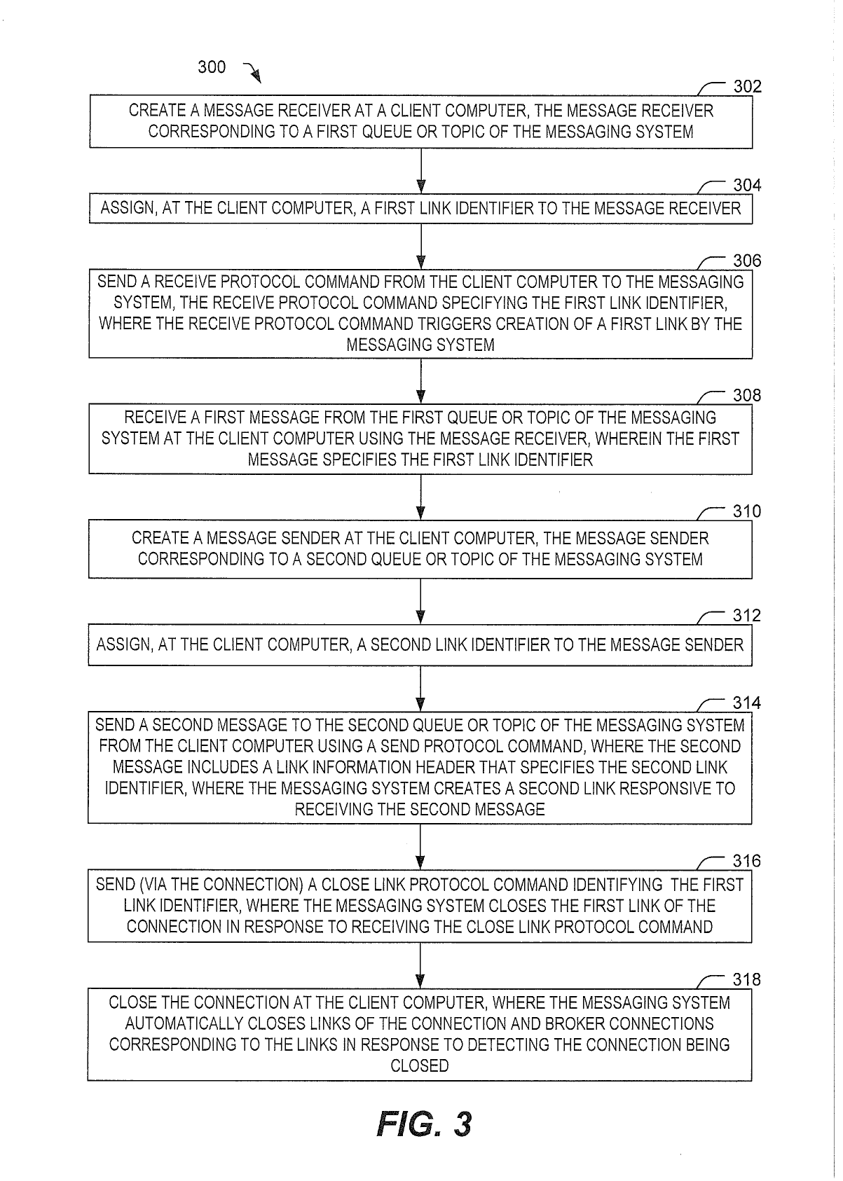

Referring to FIG. 3, a particular illustrative embodiment of a method 300 of operating a distributed messaging system including links and connections is described. The method 300 includes creating a message receiver at a client computer where the message receiver corresponds to a first queue or topic of the messaging system, at 302. For example, the message receiver 116 is created within the first client computer 102. The message receiver 116 may correspond to a first queue or topic within the messaging entities 150 of the messaging system 130.

The method 300 further includes assigning at the client computer a first link identifier to the message receiver, at 304. For example, the link identifier 109 of FIG. 1 may be assigned to the message receiver 116 of the first client computer 102. In a particular embodiment, the first client computer 102 may assign the link identifier 109 to the message receiver 116. Thus, a client computer, rather than the messaging system 130, may assign link identifiers. The method 300 further includes sending a receive protocol command from the client computer to the messaging system where the receive protocol command specifies the first link identifier and where the receive protocol command triggers creation of a first link by the messaging system, at 306. For example, the message sender 114 of the client computer 102 of FIG. 1 may send the protocol command 108 having the link identifier 109 to the messaging system 130. The receive protocol command may request that information be sent to the message receiver of the client computer from the messaging system. Thus, the receive protocol command is not a create link command, but rather, is a command that requests transmission of one or more messages from a messaging entity of the messaging system. The link identifier 109 of the protocol command message 108 may be unrecognized by the messaging system 130, since the link identifier 109 was generated by the first client computer 102. Accordingly, the protocol command message 108 may trigger creation of a first link by the messaging system 130. For example, the messaging system 130 may generate an entry for the link identifier 109 in the link mapping information 136.

The method 300 further includes receiving a first message from the first queue or topic of the messaging system at the client computer using the message receiver where the first message specifies the first link identifier, at 308. For example, a first message 112 may be sent from the messaging system 130 to the client computer 102 in response to the protocol command message 108. The first message 112 may include the link identifier 109 associated with the first link. Thus, the receive protocol command may cause the messaging system 130 to both create a new link and to send one or more messages using the new link.

The method 300 further includes creating a message sender at the client computer, where the message sender corresponds to a second queue or topic of the messaging system, at 310. For example, the message sender may be the message sender 114 of the client computer 102. The method 300 further includes assigning, at the client computer, a second link identifier to the message sender, at 312. The message sender 114 of FIG. 1 may correspond to a second link, such as link B, while the message receiver 116 may correspond to a first link, such as link A, of the first connection 120.

The method 300 further includes sending a second message to the second queue or topic of the messaging system from the client computer using a second protocol command where the second message includes a link information header that specifies the second link identifier and where the messaging system creates a second link responsive to receiving the second message, at 314. For example, a second message that includes a second link identifier (assigned by the first client computer 102) may be sent by the client computer 102 to the messaging system 130, and the messaging system 130 may create a second link (e.g. link B) corresponding to the second link identifier of the first connection 120. To illustrate, a message that is directed to a queue or topic to which the first client computer 102 does not have an open link may be sent by the first client computer 102 to the messaging system 130. In response to receiving the message, the messaging system 130 may both create a link to the first client computer 102 and send the message to the queue or topic.

The method 300 may further include sending via a connection a close link protocol command identifying the first link identifier, at 316. The messaging system may close the first link of the connection in response to receiving the close link protocol command. For example, the messaging system 130 may receive the close link protocol command via the first connection 120, and the close link protocol command may have the link identifier 109 that corresponds to link A. In response, the messaging system 130 may close link A of the connection 120 but may maintain the first connection 120 for communicating using different links.

In a particular embodiment, the method 300 may include closing a connection at the client computer, at 318. The messaging system may automatically close links of the connection and broker connections corresponding to the links in response to detecting the connection being closed. For example, the messaging system 130 of FIG. 1 may receive a close connection message or may otherwise determine to close one of the connections 120, 122, 124. For example, if the second connection 122 is to be closed, then the messaging system 130 would close each of the plurality of links C, D, E, F and corresponding broker connections to each of the links, such as broker connections within the messaging system identified as corresponding to each of the links C, D, E, F by the link mapping information 136. After automatically closing each of the links associated with the second connection 122, the second connection 122 is closed for further message traffic.

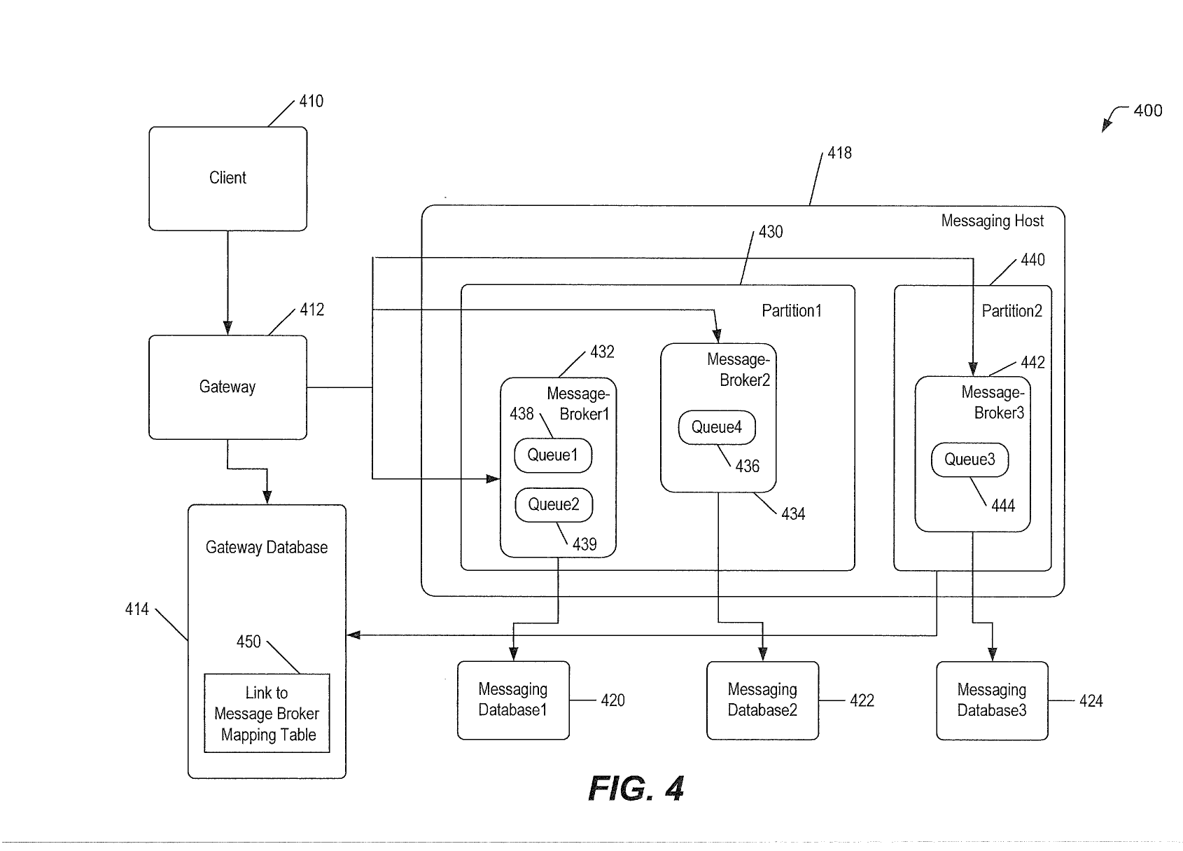

Referring to FIG. 4, a particular illustrative embodiment of a distributed messaging system 400 is shown. The distributed messaging system 400 includes a messaging host 418, a gateway 412, a gateway database 414, and a plurality of messaging databases 420, 422, and 424. The gateway database 414 includes a link to message broker mapping table 450. The link to message broker mapping table 450 may, in a particular embodiment, correspond to the link mapping information 136 of FIG. 1.

The messaging host 418 may include a plurality of partitions, such as a representative first partition 430 and a representative second partition 440. While two partitions 430, 440 have been shown, it should be understood that the messaging host 418 may include one partition or more than two partitions. The first partition 430 includes or supports execution of one or more message brokers, such as a representative first message broker 432 and a representative second message broker 434. While the first partition 430 is illustrated as including two message brokers 432, 434, it should be understood that each of the partitions 430, 440 may include one or more message brokers or no message brokers. A message broker is a software service that provides support for a variety of messaging patterns. These messaging patterns may include (but are not limited to) a queue and a topic. Queues and topics are each a type of messaging entity. Thus, the term “messaging entity” is used interchangeably herein with the term “queue”, the term “topic”, or both, unless a distinction between a queue or topic is indicated. The first message broker 432 may include one or more messaging entities, such as a first queue 438 and a second queue 439. The second message broker 434 may also include one or more messaging entities, such as a fourth queue 436. The second partition 440 includes or supports execution of a third message broker 442, which may also include one or more messaging entities, such as a third queue 444. In other embodiments, each of the queues 438, 439, 444, 436 may be replaced by another messaging entity, such as a topic, or each of the message brokers may include multiple queues and topics.

The messaging system 400 includes a plurality of message brokers and at least two of the plurality of message brokers have a message entity. For example, the first message broker 432 has messaging entities 438 and 439, and the second message broker 434 includes the messaging entity of the fourth queue 436. The messaging system 400 also includes the gateway 412, which is operable to support a connection to at least one client computer, such as the client computer 410. In a particular embodiment, the gateway 412 may correspond to, include or be included within the message interface and routing component 132 of FIG. 1. The gateway 412 is communicatively coupled to each of the plurality of message brokers, such as the message brokers 432, 434, and 442, and the gateway 412 includes a memory, such as the memory within the gateway database 414 that stores a plurality of link to broker connection mappings (e.g., entries within the link to broker message mapping table 450). Each of the entries within the link to broker mapping table 450 corresponds to a link to broker connection mapping that identifies a particular link of multiple links of a connection and a corresponding broker connection from the gateway 412 or from the gateway database 414 to one of the plurality of message brokers.

For example, each of the link to broker connection mappings of the link to message broker mapping table 450 identifies a particular link of multiple links of the connection. For example, the connection between the client computer 410 and the gateway 412 may have multiple links associated therewith. To illustrate, the connection between the client computer 410 and the gateway 412 may correspond to the first connection 120 that includes link A and link B or may correspond to any of the other connections 122, 124. In addition, for each link, the link to message broker mapping table 450 has a corresponding broker connection or identifies a corresponding broker connection from the gateway 412 to one of a plurality of message brokers of the messaging host 418. At least one of the plurality of link to broker connection mappings is associated with a link identifier that is generated by the at least one client computer 410. Thus, when the client computer 410 sends a message with a link identifier, the gateway 412 and the gateway database 414 are operable to receive the message with the link identifier and to create an entry within the link to message broker mapping table 450 that maps a particular link corresponding to the link identifier with a corresponding broker connection to one of the plurality message brokers within the messaging host 418.

While operation of the distributed system 400 has been described with respect to a particular link of a particular connection, it should be understood that the link to message broker mapping table 450 may include a plurality of entries where each entry corresponds to a different link and each entry includes mapping information between a particular link and a particular assigned message broker associated therewith. In addition, while the gateway database 414 has been shown as a distinct entity from the gateway 412, it should be understood that the gateway database 414 may be embedded within the gateway 412 or may be separated from the gateway 412 as shown in FIG. 4.

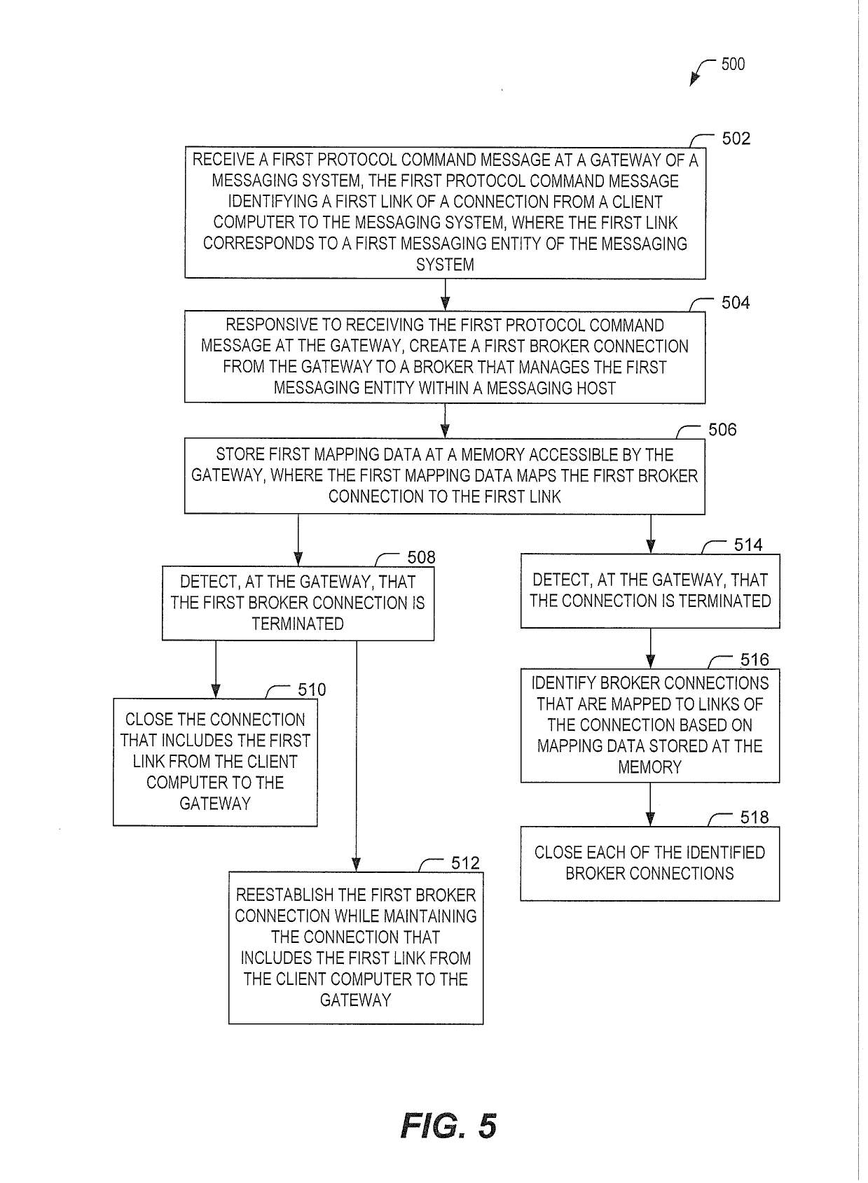

Referring to FIG. 5, a particular illustrative embodiment of a method of processing messages over connections of a distributed messaging system is shown. The method 500 includes receiving a first protocol command message at a gateway of a messaging system, where the first protocol command message identifies a first link of a connection from a client computer to the messaging system, and where the first link corresponds to a first messaging entity of the messaging system, at 502. For example, the protocol command message 108 of FIG. 1 may be received at the message interface and routing component 132 of the messaging system 130. The protocol command message 108 may include the link identifier 109, which may correspond to a first link (e.g., link A) of the first connection 120. The message interface and routing component 132 may correspond to the gateway 412 of FIG. 4. Thus, the gateway 412 may receive the first protocol command message from the client computer 410.

The method 500 further includes, responsive to receiving the first protocol command message at the gateway, creating a first broker connection from the gateway to a broker that manages the first messaging entity within a messaging host, at 504. The method 500 further includes storing first mapping data at a memory accessible by the gateway where the first mapping data maps the first broker connection to the first link, at 506. For example, the first mapping data may be stored as an entry within the link mapping information 136 of FIG. 1, where the link mapping information maps a first broker within the messaging system 130 to the first assigned link. In another example, the first mapping data may be stored as an entry within the link to message broker mapping table 450 of FIG. 4.

In some circumstances, the first broker connection may be closed or otherwise lost. In these circumstances, the method 500 further includes detecting at the gateway that the first broker connection is terminated, at 508. Upon detecting that the broker connection is terminated, the method 500 may include closing the connection that includes the first link from the client computer to the gateway, at 510. Alternately, the method 500 may include reestablishing the first broker connection while maintaining the connection that includes the first link from the client computer to the gateway, as shown at 512. Thus, all links of a particular connection may be closed and the connection may be closed in response to detecting a broker termination (e.g., at 510), or a broker connection may be terminated but then may be reestablished while the connection corresponding to the link associated with a particular broker connection is maintained (e.g., at 512). Maintaining a particular connection while terminating and then reestablishing a broker corresponding to a link of the connection may beneficially allow efficient link creation and termination handling.

In some circumstances, the connection to the client computer may be closed or otherwise lost. In these circumstances, the method 500 further includes detecting, at the gateway, that the connection is terminated, at 514. The method 500 may also include in response to detecting that the connection is terminated, identifying broker connections that are mapped to links of the connection based on mapping data stored at the memory, at 516. For example, the identified broker connections may include a first broker connection (e.g. corresponding to link A) and a second broker connection (e.g. corresponding to link B). The method 500 may further include closing each of the identified broker connections, at 518. Thus, broker connections that correspond to a lost or closed client computer connection may be closed automatically, e.g., without receiving a close connection command from the client computer.

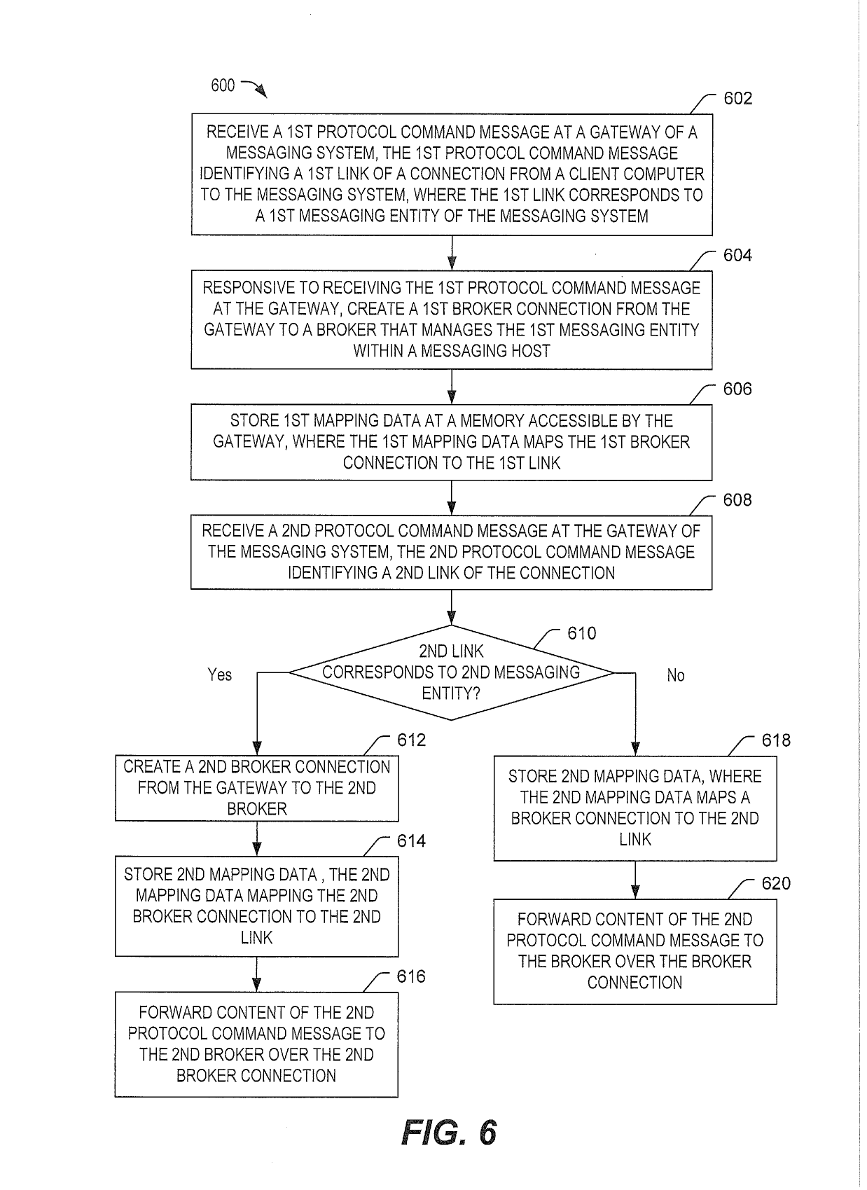

Referring to FIG. 6, a particular illustrative embodiment of a method 600 of processing messages at a distributed messaging system is shown. The method 600 includes receiving a first protocol command message at a gateway of a messaging system where the first protocol command message identifies a first link of a connection from a client computer to the messaging system and where the first link corresponds to a first messaging entity of the messaging system, at 602. For example, the gateway may correspond to the message interface and routing component 132 of FIG. 1, which may receive the protocol command message 108 including the link identifier 109 from the first client computer 102 via the first connection 120. In this example, the link identified by the link identifier 109 may be associated with a particular messaging entity of the messaging entities 150. In another example, the client computer 410 of FIG. 4 may send the first protocol command message to the gateway 412. In this example, the first protocol command message may be associated with a link to a message broker, such as the first message broker 432, or a link to a particular messaging entity, such as the first queue 438.

The method 600 further includes, responsive to receiving the first protocol command message at the gateway, creating a first broker connection from the gateway to a broker that manages the first messaging entity within a messaging host, at 604. The method 600 further includes storing first mapping data at a memory accessible by the gateway where the first mapping data maps the first broker connection to the first link, at 606. For example, the first mapping data may be stored in the link mapping information 136 within the memory 134 of FIG. 1, and the first mapping data may map the first broker connection to the first link within the link mapping information 136. In another example, the first mapping data may be stored as an entry in the link to message broker mapping table 450.

The method 600 further includes receiving a second protocol command message at the gateway of the messaging system, the second protocol command message identifying a second link of the connection, at 608. For example, the second protocol command message may include a second link identifier that is different than a link identifier of the first protocol command message. The method 600 further includes evaluating the second link identifier to determine whether the second link corresponds to a second messaging entity, at 610. For example, the second link identifier may be compared to information from the link mapping information 136 of FIG. 1 or to an entry of the link to message broker mapping table 450 to determine whether a link corresponding to the second link identifier already exists. If the second link does not correspond to the second messaging entity (e.g., if the second link identifier is not found in the link mapping information 136 or in the link to message broker mapping table 450), at 610, the method 600 proceeds to store second mapping data where the second mapping data maps a broker connection to the second link, at 618, and forwards content of the second protocol command message to a broker over the first broker connection, at 620. In a particular embodiment, the broker connection is the first broker connection used for the first link and the broker is the first broker that manages the first messaging entity and the second messaging entity.

If, at 610, the second link corresponds to the second messaging entity, then the method 600 proceeds to create a second broker connection from the gateway to the second broker (that manages the second messaging entity), at 612, to store second mapping data (where the second mapping data maps the second broker connection to the second link), at 614, and to forward content of the second protocol command message to the second broker over the second broker connection, at 616.

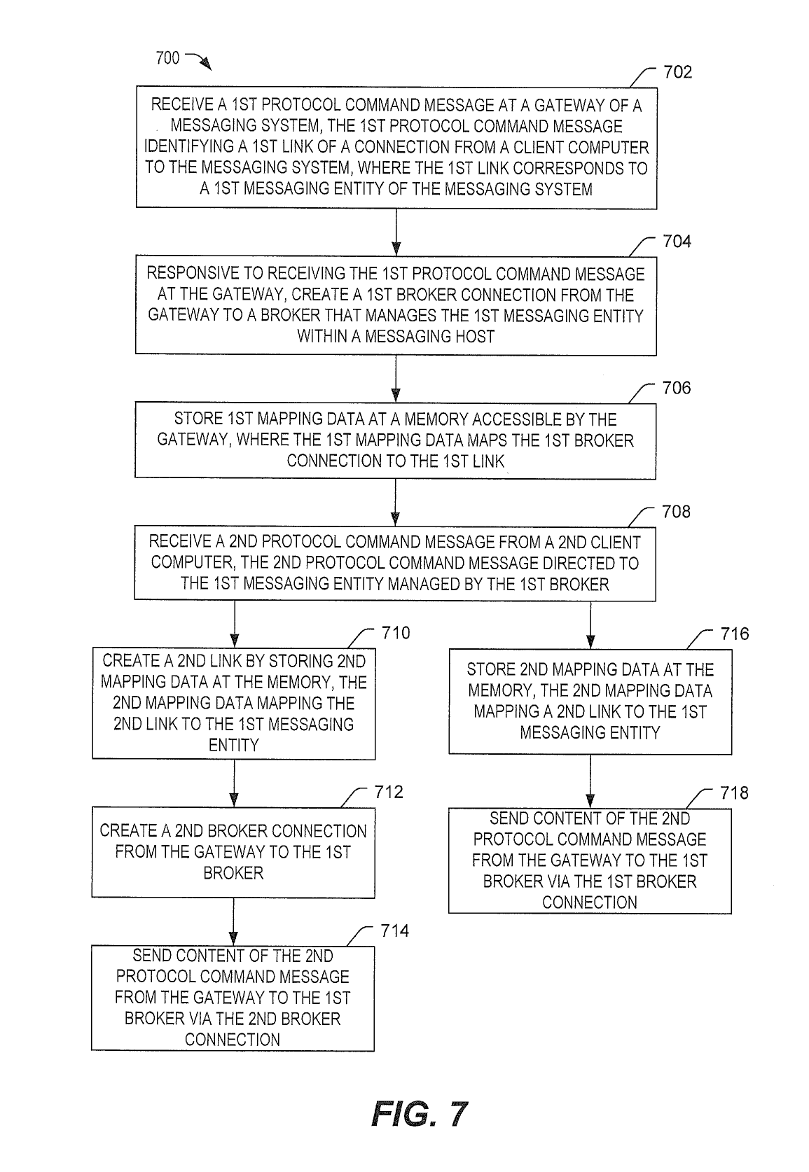

Referring to FIG. 7, a flow chart that illustrates another embodiment of a method 700 of processing messages at a distributed messaging system is shown. The method 700 includes receiving a first protocol command message at a gateway of a messaging system where the first protocol command message identifies a first link of a connection from a client computer to the messaging system, and where the first link corresponds to a first messaging entity of the messaging system, at 702. For example, the gateway may correspond to the message interface and routing component 132 of FIG. 1, which may receive the protocol command message 108 including the link identifier 109 from the first client computer 102 via the first connection 120. In this example, the link identified by the link identifier 109 may be associated with a particular messaging entity of the messaging entities 150. In another example, the client computer 410 of FIG. 4 may send the first protocol command message to the gateway 412. In this example, the first protocol command message may be associated with a link to a message broker, such as the first message broker 432, or a link to a particular messaging entity, such as the messaging entity 438.

The method 700 further includes, in response to receiving the first protocol command message at the gateway, creating a first broker connection from the gateway to a broker that manages the first messaging entity within a messaging host, at 704. The method 700 further includes storing first mapping data at a memory accessible by the gateway, at 706. The first mapping data maps the first broker connection to the first link. For example, the first mapping data may be stored in the link mapping information 136 within the memory 134 of FIG. 1, and the first mapping data may map the first broker connection to the first link within the link mapping information 136. In another example, the first mapping data may be stored as an entry in the link to message broker mapping table 450.

The method 700 further includes receiving a second protocol command message from a second client computer, at 708. The second protocol command message is directed to the first messaging entity managed by the first broker. The method 700 may further include storing second mapping data at the memory, where the second mapping data maps a second link to the first messaging entity, at 716, and sending the content of the second protocol command message from the gateway to the first broker via the first broker connection, at 718.

Alternatively, the method 700 may include creating a second link by storing the second mapping data at the memory, where the second mapping data maps the second link to the first messaging entity, at 710, creating a second broker connection from the gateway to the first broker, at 712, and sending content of the second protocol command message from the gateway to the first broker via the second broker connection, at 714.

In a particular embodiment, each protocol command message that is transmitted over a connection includes a link identifier in a link information header. The link identifier (or “LinkId”) may include a string or other value that uniquely identifies its associated link. In a particular client implementation, the LinkId is a monotonically increasing positive integer, but the LinkID may be any (locally or globally) unique string.

In a particular embodiment, the creation of a link is performed on demand when a protocol command message (e.g., send, receive, etc.) is received by the messaging system with an unrecognized LinkId. Creating links on demand reduces a number of network round trips used to setup links and communicate data (e.g., content of the protocol command message). Additionally, a client's reconnect logic can be simplified and explicit “Create Link” commands can be eliminated. Further, in the case of disconnect, the client does not have to resend multiple “Create Link” protocol commands to recreate links that were lost. Instead, the next protocol command that is sent by the client on each link will include in its LinkInfo header the information needed for the messaging system to re-create the corresponding link.

An example of a link information header, represented in XML is:

<LinkInfo
xmlns=“http://schemas.microsoft.com/servicebus/2010/08/protocol/”>

<EntityName>MyQueue1</EntityName>
<LinkId>l<LinkId>
<LinkType>[Receive|Send|Control]</LinkType>
<ReceiveMode>[ReceiveAndDelete|PeekLock]</ReceiveMode>
<EntityType>[Queue|Topic]</EntityType>
<IsSessionReceiver>[false|true]</IsSessionReceiver>

</LinkInfo>

In a particular embodiment, a MessageSender or MessageReceiver of a client may close a link by sending a close link command message with a link information header that indicates to the messaging system which link the client is closing. The client may alternately close the entire connection. Closing a connection implicitly instructs the messaging system to close all of the links associated with the connection. An example of a method of operation is provided below along with pseudo code describing particular steps executed by a messaging system (such as at the message interface and routing component 132 or at the gateway 412 of FIG. 4):

Step 1: Client creates a MessageReceiver to Queue1

// Note: No Protocol Commands or link creation commands are sent
by the Client

Step 2: Client creates a MessageSender to Topic2

// Note: No Protocol Commands or link creation commands are sent
by the Client

Step 3: Client Receives a Message using MessageReceiver to Queue1

// Client sends a Receive Protocol Command that include a link
identifier (e.g., LinkId = 1)
// Messaging System receives the Receive Protocol Command and

creates a new MessageReceiver Link associated with the LinkId = 1

<s:envelope>

<s:headers>

<LinkInfo>

<EntityName>Queue1</EntityName>
<LinkId>1</LinkId>
<LinkType>Receive</LinkType>
<ReceiveMode>ReceiveAndDelete</ReceiveMode>

</LinkInfo>

</s:headers>
<s:body>

<ReceiveCommand>

<MessageCount>1</MessageCount>

</ReceiveCommand>

</s:body>

</ s:envelope >

Step 4: Client Sends a Message using MessageSender to Topic2

// Client sends a Send Protocol Command with a second link
identifier (e.g., LinkId = 2)
// Messaging System creates a new MessageSender Link associated
with the LinkId = 2
<s:envelope>

<s:headers>

<LinkInfo>

<EntityName>Topic2</EntityName>
<LinkId>2</LinkId>
<LinkType>Send</LinkType>

<LinkInfo>

</s:headers>
<s:body>

<SendCommand>

<Message>BASE64DATAHERE</Message>

</SendCommand>

</s:body>

</ s:envelope >

Step 5: Client Closes MessageReceiver to Queue1

// Client sends a CloseLink Protocol Command with the LinkId = 1
// Messaging System closes the existing MessageReceiver Link
associated with the LinkId = 1
<s:envelope>

<s:headers>

<LinkInfo>

<EntityName>Queue1</EntityName>
<LinkId>1</LinkId>
<LinkType>Receive</LinkType>
<ReceiveMode>ReceiveAndDelete</ReceiveMode>

</LinkInfo>

</s:headers>
<s:body>

<CloseLink>

</s:body>

</ s:envelope>

Step 6: Client Closes Connection

// Client does not send any Protocol Commands or close connection
commands
// Messaging System detects that the Connection is closed and cleans

up the associated links, such as the MessageSender to Topic2 link
associate with LinkId = 2

An example method of reconnecting a link is provided below along with pseudo code describing particular steps executed by a messaging system (such as at the message interface and routing component 132 or at the gateway 412 of FIG. 4):

Step 1: Client creates a MessageSender to Queue1

//No Protocol Commands or link creation commands are sent by the
Client

Step 2: Client Sends first Message using MessageSender to Queue1

// Client sends a Send Protocol Command with a link identifier (e.g.,
LinkId = 1)
// Messaging System creates a new MessageSender associated with
the LinkId = 1
<s:envelope>

<s:headers>

<LinkInfo>

<EntityName>Queue1</EntityName>
<LinkId>1</LinkId>
<LinkType>Send</LinkType>

</LinkInfo>

</s:headers>
<s:body>

<SendCommand>

<Message>BASE64DATAHERE</Message>

</SendCommand>

</s:body>

</ s:envelope >

Step 3: Client closes connection (e.g., the user closes his or her laptop
computer and drives home)

// No Protocol Commands or close connection commands are sent by
the client
// An underlying network/socket connection disconnects
//Messaging System detects loss of network/socket connection and

closes links associated with the connection, including LinkId = 1
Step 4: Client reestablished connection or opens new connection (e.g., the
user opens the laptop computer at home)

// No Protocol Commands or reconnect commands are sent by the

client to the messaging system
Step 5: Client sends a second Message using the MessageSender to
Queue1. Due to the connection having been lost this will establish a new
network connection, and the Messaging System will create a new Link at
this time:

// New underlying network/socket connection is established at the
client
// Client sends a Send Protocol Command with LinkId = 1
// Messaging System creates a new MessageSender associated with
LinkId = 1
<s:envelope>

<s:headers>

<LinkInfo>

<EntityName>Queue1</EntityName>
<LinkId>1</LinkId>
<LinkType>Send</LinkType>

</LinkInfo>

</s:headers>
<s:body>

<SendCommand>

<Message>BASE64DATAHERE</Message>

</SendCommand>

</s:body>

</ s:envelope >

Step 6: Client Sends a third Message using MessageSender to Queue1.

// Client sends a Send Protocol Command including LinkId = 1
// Messaging System uses the existing MessageSender Link
associated with LinkId = 1
<s:envelope>

<s:headers>

<LinkInfo>

<EntityName>Queue1</EntityName>
<LinkId>1</LinkId>
<LinkType>Send<LinkType>

</LinkInfo>

</s:headers>
<s:body>

<SendCommand>

<Message>BASE64DATAHERE</Message>

</SendCommand>

</s:body>

</ s:envelope >

Thus, message content can be sent from a client computer to a messaging entity, such as a queue or topic, via a single protocol command message, even when no link between the messaging system and the client computer has previously been established. Further, links do not need to be reestablished after a loss of a connection since any subsequently sent message will automatically reestablish the associated link.

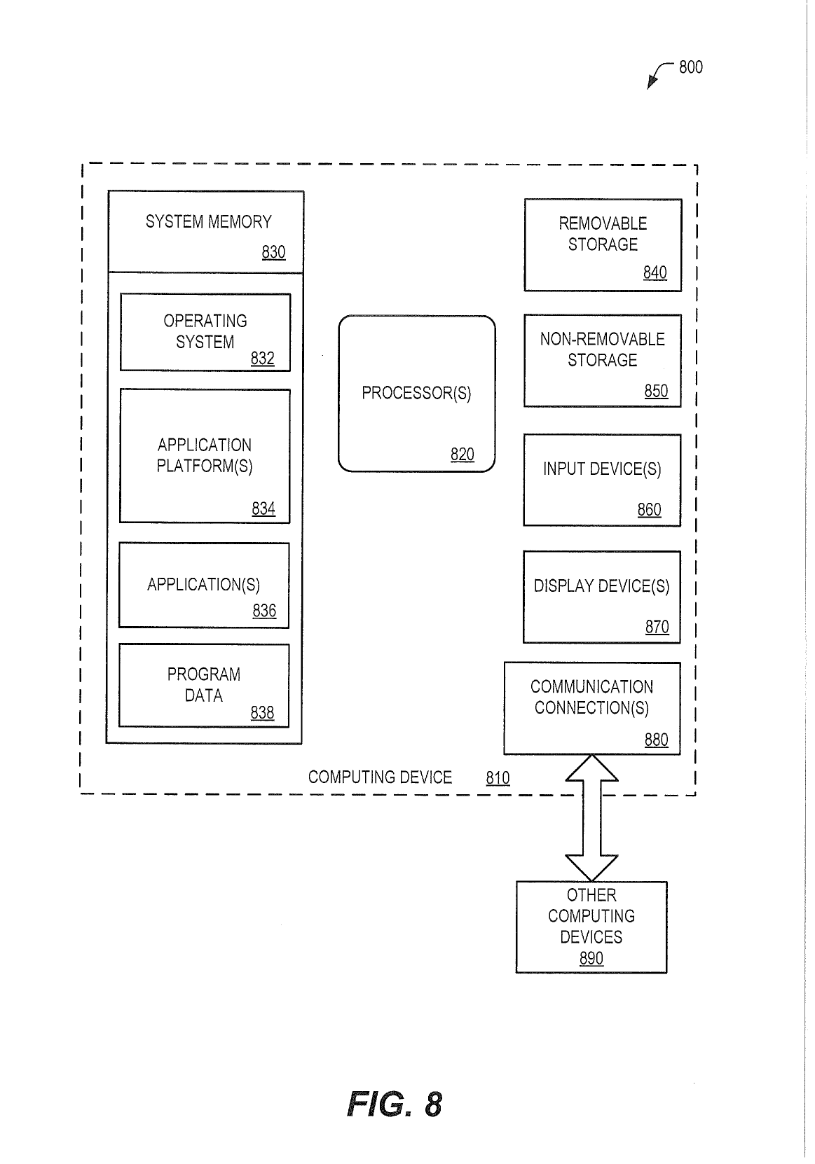

FIG. 8 depicts a block diagram of a computing environment 800 including a computing device 810 operable to support embodiments of computer-implemented methods, computer program products, and system components according to the present disclosure. In an illustrative embodiment, the computing device 810 may include or be used to implement one or more of the client computers 102, 104, 106, 410, the messaging system 130 (and any components therein), the gateway 412, the gateway database 414, the messaging host 418 (and any components therein), any of the messaging databases 420, 422, 424 of FIG. 4, or any of the message brokers 432, 434, 442 of FIG. 4.

The computing device 810 includes at least one processor 820 and a system memory 830. Depending on the configuration and type of the computing device 810, the system memory 830 may be volatile (such as random access memory or “RAM”), non-volatile (such as flash memory and similar memory devices that maintain stored data even when power is not provided), or some combination of the two. The system memory 830 typically includes an operating system 832, one or more application platforms 834, one or more applications 836, and may include program data 838 associated with the one or more applications 836. In an illustrative embodiment, the applications 836 include distributed messaging system applications. The application platforms 834 may include partitioning logic, such as a partitioning system of a clustered computing environment configured to support message brokers as described with respect to the distributed messaging system 100, 400. The distributed messaging system applications may include applications for implementing the messaging system 130, the message interface and routing component 132, or the messaging entities 150 of FIG. 1. The distributed messaging system applications may also or in the alternative include applications for implementing the gateway 412, the gateway database 414, or any of the message brokers 432, 434, or 442 of FIG. 4. In addition, the applications 836 may support one or more of the messaging databases 420, 422, or 424.

The computing device 810 may also have additional features or functionality. For example, the computing device 810 may also include removable and/or non-removable additional data storage devices, such as magnetic disks, optical disks, tape, and standard-sized or miniature flash memory cards. Such additional storage is illustrated in FIG. 8 by removable storage 840 and non-removable storage 850. Computer storage media may include volatile and/or non-volatile storage and removable and/or non-removable media implemented in any method or technology for storage of information, such as computer-readable instructions, data structures, program components or other data. The system memory 830, the removable storage 840 and the non-removable storage 850 are all examples of computer storage media. The computer storage media may include, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other tangible medium that can be used to store information and that can be accessed by the computing device 810. Any such computer storage media may be part of the computing device 810.

The computing device 810 may also have input device(s) 860, such as a keyboard, mouse, pen, voice input device, touch input device, etc. Output device(s) 870, such as a display, speakers, printer, etc. may also be included. The computing device 810 also contains one or more communication connections 880 that allow the computing device 810 to communicate with other computing devices 890 over a wired or a wireless network. The other computing devices 890 may include databases or clients. For example, the other computing devices 890 may include any of the client computers 102, 104, 106 or any of the databases described with respect to the distributed messaging system 100 as shown in FIG. 1 or any of the components of the messaging system 400 as shown in FIG. 4.

It will be appreciated that not all of the components or devices illustrated in FIG. 8 or otherwise described in the previous paragraphs are necessary to support embodiments as herein described. For example, the input device(s) 860 and output device(s) 870 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process or instruction steps described in connection with the embodiments disclosed herein may be implemented as electronic hardware, computer software, or combinations of both. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of creating a link of a connection to a messaging system, the method comprising:
receiving a protocol command message directed to a message entity of the messaging system, the protocol command message communicated over the connection;
determining that the protocol command message includes a link identifier that is unrecognized by the messaging system; and
in response to receiving the protocol command message and determining that the protocol command message includes the link identifier that is unrecognized by the messaging system, creating the link for the connection, the link corresponding to the link identifier.

2. The method of claim 1, wherein the protocol command message includes a link information header that indicates a messaging entity name, the link identifier, a link type, a receive mode, a connection identifier, and an entity type.

3. The method of claim 2, wherein the link type is one of receive, send, and control, wherein the receive mode is one of receive mode, delete mode, and peek lock mode, wherein the entity type is one of queue and topic, and wherein the link information header further includes information indicating whether the link is associated with a session receiver.

4. The method of claim 1, further comprising:
receiving a close link command message that includes the link identifier; and
closing the link in response to the close link command message.

5. The method of claim 4, wherein the connection is maintained when the link is closed.

6. The method of claim 5, further comprising, after the link is closed:
receiving a second protocol command message via the connection, the second protocol command message including the link identifier; and
automatically creating a second link in response to receiving the second protocol command message, the second link associated with the link identifier.

7. The method of claim 1, wherein the connection includes a plurality of links, the method further comprising:
receiving a close connection indication; and
closing each of the plurality of links in response to receiving the close connection indication.

8. The method of claim 1, wherein the protocol command message is a command other than a create link command and wherein the link identifier corresponds to at least one communication from a client computer, wherein the message entity is a queue or a topic, and wherein the link is unidirectional.

9. The method of claim 1, wherein creating the link includes generating mapping data that associates the link identifier with a message broker of the messaging system.

10. A method of using a messaging system, the method comprising:
creating a message receiver at a client computer, the message receiver corresponding to a first queue or topic of the messaging system;
assigning, at the client computer, a first link identifier to the message receiver;
sending a receive protocol command from the client computer to the messaging system, the receive protocol command specifying the first link identifier, wherein the receive protocol command triggers creation of a first link by the messaging system; and
receiving a first message from the first queue or topic of the messaging system at the client computer using the message receiver, wherein the first message specifies the first link identifier.

11. The method of claim 10, further comprising:
creating a message sender at the client computer, the message sender corresponding to a second queue or topic of the messaging system;
assigning, at the client computer, a second link identifier to the message sender; and
sending a second message to the second queue or topic of the messaging system from the client computer using a send protocol command, wherein the second message includes a link information header that specifies the second link identifier, wherein the messaging system creates a second link responsive to receiving the second message.

12. The method of claim 11, wherein the first link and the second link are two of multiple links of a connection that enables message communication with respect to the client computer and the messaging system.

13. The method of claim 12, further comprising sending a close link protocol command identifying the first link identifier, wherein the close link protocol command is sent over the connection from the client computer to the messaging system, and wherein the messaging system closes the first link of the connection in response to receiving the close link protocol command.

14. The method of claim 12, further comprising closing the connection at the client computer, wherein the messaging system closes the first link and the second link in response to detecting the connection being closed, and wherein a gateway of the messaging system closes broker connections corresponding to the first link and the second link in response to detecting the connection being closed.

15. The method of claim 10, wherein the first link identifier is unknown to the messaging system when the receive protocol command is sent.

16. A method of routing messages at a gateway of a messaging system, the method comprising:
receiving a first protocol command message at the gateway of the messaging system, the first protocol command message identifying a first link of a connection from a client computer to the messaging system, wherein the first link corresponds to a first messaging entity of the messaging system;
responsive to receiving the first protocol command message at the gateway, creating a first broker connection from the gateway to a broker that manages the first messaging entity within a messaging host; and
storing first mapping data at a memory accessible by the gateway, wherein the first mapping data maps the first broker connection to the first link.

17. The method of claim 16, further comprising:
receiving a second protocol command message at the gateway of the messaging system, the second protocol command message identifying a second link of the connection, wherein the second link corresponds to a second messaging entity of the messaging system; and
responsive to determining that the second messaging entity is managed by the first broker, forwarding content of the second protocol command message to the first broker over the first broker connection.

18. The method of claim 16, further comprising:
receiving a second protocol command message at the gateway of the messaging system, the second protocol command message identifying a second link of the connection, wherein the second link corresponds to a second messaging entity of the messaging system; and
responsive to determining that the second messaging entity is managed by a second broker:
creating a second broker connection from the gateway to the second broker;
storing second mapping data at the memory accessible the gateway, the second mapping data mapping the second broker connection to the second link; and
forwarding content of the second protocol command message to the second broker over the second broker connection.

19. The method of claim 16, wherein the messaging system comprises a plurality of message brokers, at least two of the plurality of message brokers having a message entity, wherein the gateway is operable to support a connection to at least one client computer, wherein the gateway is communicatively coupled to each of the plurality of message brokers, wherein the gateway includes a memory that stores a plurality of link to broker connection mappings, and wherein each of the link to broker connection mappings identifies a particular link of multiple links of the connection and a corresponding broker connection from the gateway to one of the plurality of message brokers.

20. The method of claim 19, wherein at least one of the plurality of link to broker connection mappings is associated with a link identifier generated by the at least one client computer.
